(19) United States
(12) Patent Application Publication
(10) Pub. No.: US 2008/0074867 A1
(43) Pub. Date: Mar. 27, 2008

(54) Solar powered outdoor flicker light

(75) Inventor: Chi Gon Chen, Guang Zhou (CN)

Correspondence Address: STRASBURGER & PRICE, LLP, 901 MAIN STREET, SUITE 4400, DALLAS, TX, 75202, US

(73) Assignee: International Development Corp.

(21) Appl. No.: 11/903,426

(22) Filed: Sep. 21, 2007

Related U.S. Application Data
(60) Provisional application No. 60/846,253, filed on Sep. 21, 2006.

(51) Int. Cl. F21L 4/08; H05B 41/36

(52) U.S. Cl. 362/183; 315/152

(57) ABSTRACT

A solar powered outdoor flicker light includes a plurality of light emitting diodes behind a light diffusing lens portion. The flickering of a portion of the emitting diodes is controlled by an astable multi-vibrator circuit. The flickering of the light emitting diodes gives the appearance of a flickering candle flame when viewed through the light diffusing lens portion.

### CROSS REFERENCE TO RELATED APPLICATION

This application claims the benefit of Provision U.S. Patent Application No. 60/846,253 filed Sep. 21, 2006.

### STATEMENT REGARDING FEDERALLY FUNDED RESEARCH AND DEVELOPMENT

The invention described in this patent application was not the subject of federally sponsored research or development

### FIELD

The present invention pertains to outdoor lighting, more particularly, the present invention pertains to solar powered outdoor lighting.

### BACKGROUND

The past few years have seen rapid development in both the technology associated with solar panels and the technology associated with light emitting diodes. Specifically, while solar panels were once almost a novelty item or an item used only in remote locations, both the cost of solar panels has decreased and the output of electrical energy from solar panels has increased. Similarly, while light emitting diodes had only limited applications for many years, both the cost of light emitting diodes has decreased and the output of light energy has increased. Accordingly, the power available from solar panels has grown to a level where the power requirements for a light emitting diode having an acceptable light output level for use in an outdoor setting can now be met with a solar panel. Similarly, the cost of both solar panels and light emitting diodes have both decreased to the point where an outdoor light fixture using electrical energy obtained from solar panels and emitting light from light emitting diodes is affordable to most homeowners.

The convergence of the development of the technology associated with solar panels and the technology associated with light emitting diodes has created a market where small outdoor lighting fixtures used to mark walkways or to enhance the appearance of landscaping are now in demand by homeowners. These small outdoor lighting fixtures include solar panels to capture light energy and then turn the light energy into electrical energy. The electrical energy is then stored in a battery and then directed, when needed, to an array of light emitting diodes which illuminate on receipt of the electrical energy obtained from the battery.

Early outdoor lighting fixtures using a solar panel to provide the electrical power for light emitting diodes simply provided continuous illumination of an LED when sufficient electrical power was available. Such outdoor lighting fixtures providing continuous illumination, while satisfactory, did not provide users with an array of creative lighting effects. Accordingly, a need remains in the art for a solar powered outdoor lighting fixture which creates a different effect than simple continuous illumination.

### SUMMARY

The outdoor lighting fixture of the present invention provides a solar powered lighting fixture having a different lighting effect than simple continuous illumination. More specifically, the outdoor lighting fixture of the present invention provides a solar powered lighting fixture using a plurality of light emitting diodes which flicker in such a manner that the solar powered outdoor lighting fixture gives the appearance of containing a candle when the light from the light emitting diodes is diffused through a light diffusing lens portion of the light fixture.

The appearance of a flickering candle behind the light diffusing lens portion is accomplished by the use of an array of light emitting diodes. This array of light emitting diodes is positioned to give the appearance of a candle flame when the emitted light is viewed through the light diffusing lens portion. The electrical circuitry governing the supply of stored electrical power from the solar panel causes one light emitting diode to remain on continuously and the remaining light emitting diodes to turn on and off with respect to one another. That is, if one light emitting diode is on, another light emitting diode is turned off. This repeated cycling of the light emitting diodes on and off is so rapid that the viewer gets the impression that the pattern of light observed through the light diffusing lens portion of the fixture appears to be coming from a flickering candle.

### BRIEF DESCRIPTION OF THE DRAWING FIGURES

A better understanding of the outdoor flicker light of the present invention may be had by an understanding of the attached drawing figures wherein:

FIG. 1 is a perspective view of the outdoor flicker light of the present invention mounted on a pole;

FIG. 2 is a perspective view of the array of light emitting diodes extending downwardly from the top portion of the outdoor flicker light which produces the appearance of a flickering candle when viewed through the light diffusing lens portion of the outdoor light fixture; and

FIG. 3 is a schematic of the circuitry which controls the illumination of the light emitting diodes shown in FIG. 2.

### DESCRIPTION OF THE EMBODIMENTS

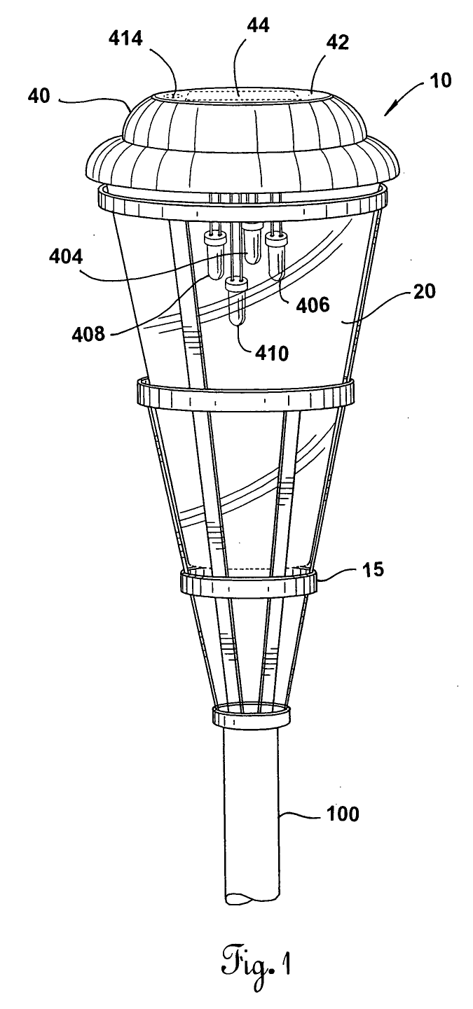

As may be seen in FIG. 1, the preferred embodiment of the outdoor flicker light 10 of the present invention shown mounted on a pole 100 has a substantially circular upside-down conical shape. A light diffusing lens portion 20 for the diffusion of light is shown supported in a frame assembly 15, such light diffusing lens portion 20 may include an etched surface, a pattern—such as a waffle pattern formed or cut in the lens portion, or a coating for diffusion of light rays observed. Those of ordinary skill in the art will understand that numerous other frame assembly types and shapes may be used along with various types and shapes of light diffusing lenses.

On top of the outdoor light fixture 10 and over the light diffusing lens portion 20 is located a top or hat portion 40. The top or hat portion 40 is constructed and arranged to cover the opening at the top of the light diffusing lens portion 20. On the top 42 of the top or hat portion 40 is located a solar panel 44 which receives light energy and converts light energy from the sun into electrical energy. Also on top 42 of the hat portion 40 is a light sensor 414 whose utility will be explained below. If a crystalline solar panel 44 is used, then the outdoor flicker light 10 must be located where it will receive sunlight during the daylight hours. If an amorphous solar panel 44 is used, then ambient light, even on a cloudy day, will be sufficient to produce the electrical energy necessary to cause the light emitting diodes to emit light upon receipt of electrical energy.

Located within the top or hat portion 40 is an arrangement of electrical componentry forming a circuit 60 (see description of FIG. 3 below) which governs the flow of electrical energy to the light emitting diodes 404, 406, 408 and 410. The circuit 60 receives electrical energy from the solar panel 44 and directs this electrical energy to a rechargeable battery 400. The electrical energy from the rechargeable battery 400 is supplied to the light emitting diodes 404, 406, 408 and 410 as will be explained below.

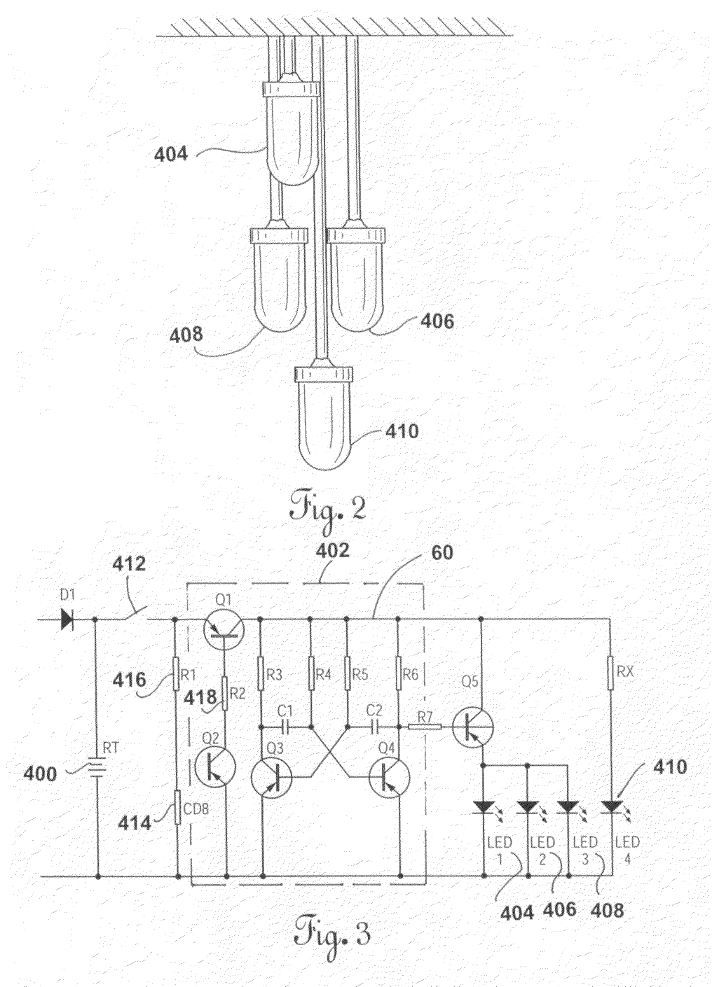

Shown in FIG. 2 is the physical arrangement of the light emitting diodes 404, 406, 408 and 410. Note that the electrical leads from the light emitting portion of the light emitting diodes extend upwardly into the top or hat portion 40. To simulate the flickering of a candle the lower most light emitting diode 410 is on continuously. The remaining light emitting diodes 404, 406 and 408 flicker on and off. In the preferred embodiment the flicker rate of the top light emitting diode 404 is set to be slower than the flicker rate of the two light emitting diodes 406 and 408 in the middle.

Controlling the flicker rate of the light emitting diodes 404, 406, 408 and 410 is an arrangement of electrical componentry forming the circuit illustrated in FIG. 3. The rechargeable battery 400 in the circuit, as described above, provides power to the circuit 60. To reduce the cost of the circuit 60 by using the minimal number of electrical components, the flicker rate of the light emitting diodes which turn on and off is made to be dependent on one another. Specifically, when one light emitting diode is on, another light emitting diode is off. Such dependent interrelationship of the flicker rate of the light emitting diodes, one to another, minimizes the number of transistors, capacitors and resistors needed in the circuit 60 shown in FIG. 3.

Referring now to FIG. 3, a schematic of a flicker control circuit 60 constructed in accordance with an embodiment of the present invention is provided. The exemplary circuit 60 is comprised of transistors, capacitors, resistors, a light sensor, light emitting diodes and a power source. The preferred embodiment is powered by a power source 400, such as a rechargeable battery coupled to the solar panel 44. The power source 400 is used to provide current to a flicker circuit 402 and four light emitting diodes (“LEDs”) 404, 406, 408 and 410 when a switch 412 is in the closed position.

A light sensor 414 and other circuit elements are included in the preferred embodiment to turn the LEDs 404, 406, 408 and 410 on and off when the light sensor 414 detects a certain level of light. The light sensor 414 should be isolated from the LEDs 404, 406, 408 and 410 so that the light sensor 414 does not receive light from the LEDs 404, 406, 408 and 410. When the light sensor 414 detects a certain level of light above a predetermined threshold (for example, the light sensor 414 is exposed to sunlight), its resistance becomes very low. The light sensor 414 is connected to the base of a first transistor Q2 (e.g., an npn BJT). Thus, when the resistance of the light sensor 414 is low, a voltage drop is induced across a resistor 416 and the voltage at the base of the first transistor Q2 drops to a level that turns the first transistor Q2 off. Furthermore, with first transistor Q2 off, the second transistor Q1 (e.g., an pnp BJT) is off. Thus, the rest of the circuit is isolated from the power source 400 and consequently the LEDs 404, 406, 408 and 410 are off.

When the light sensor 414 detects a light level below a predetermined threshold (e.g., the sensor is exposed to darkness), the resistance of the light sensor 414 rises to a level where the first transistor Q2 is turned on. When the first transistor Q2 turns on, current flows through a resistor 418 thereby turning on the second transistor Q1. With the second transistor Q1 conducting, current from the power source 400 is provided to the LED 410. When the second transistor Q1 is on, the state of the LEDs 404, 406 and 408 is determined by a third transistor Q3 (e.g., a pnp BJT). The collector of the third transistor Q3 is coupled to the LEDs 404, 406 and 408. When the third transistor Q3 is on (and the second transistor Q1 is on), current from the power source 400 is supplied to the LEDs 404, 406 and 408 (causing the LEDs to turn on).

The flickering circuit 402 turns on and off the third transistor Q3 which determines whether current is provided to the LEDs 404, 406 and 408. The flicker circuit 402 includes a flip flopping fourth transistor Q4 and a fifth transistor Q5. In this exemplary embodiment, an astable multi-vibrator circuit portion is shown. The astable multi-vibrator circuit provides a square wave voltage at a frequency rate determined by the resistor and capacitor values used in the circuit. That is, the transistors Q4 and Q5 may be conducting or not conducting depending upon RC timing circuits as noted by capacitors C1 and C2 and resistors R4 and R5. Due to the characteristics of the transistors (although FIG. 3 indicates both transistors are of the same type, in this case, npn BJTs, they both have slight differences in characteristics) and the RC circuits, the flickering circuit 402 provides a voltage to the base of the third transistor Q3 that turns the third transistor Q3 on or off. The third transistor Q3 turns on and off in a predetermined fashion causing the LEDs 404, 406 and 408 to all turn on and off in a predetermined fashion. Adjusting the resistance and capacitance values of the RC circuits adjust the frequency of the subsequent voltages supplied to the LEDs 404, 406 and 408, thereby causing the flickering which gives the appearance to the observer that a candle is located behind the light diffusing lens portion.

While the present invention has been disclosed according to its preferred and alternate embodiments, those of ordinary skill in the art will understand the other embodiments have been enabled by the foregoing description. Such other embodiments shall be included in the scope and meaning of the appended claims.

What is claimed is:

1. A solar powered outdoor flicker light, said solar powered outdoor flicker light comprising:
a light diffusing lens portion;
a hat portion constructed and arranged to fit on top of said light diffusing lens portion, said hat portion including a solar panel and electrical componentry;
an array of light emitting diodes extending downwardly from said hat portion into said light diffusing lens portion, said array of light emitting diodes including a lowermost light emitting diode, an uppermost light emitting diode and at least one light emitting diode therebetween;
said light emitting diodes being electrically connected to said electrical componentry so that one of said emitting diodes will remain on continuously and said other light emitting diodes will flicker at a rate dependent on the flickering of said other light emitting diodes;
whereby the appearance of the light passing through said light diffusing lens portion gives the appearance of a candle contained therein.

2. The solar powered outdoor flicker light as defined in claim 1 wherein said electrical componentry includes a light sensor to turn off said light emitting diodes when said light sensor detects a predetermined level of light.

3. The solar powered outdoor flicker light as defined in claim 2 wherein said light sensor is positioned to be isolated from said light emitting diodes.

4. The solar powered outdoor flicker light as defined in claim 2 wherein the detection of light below a predetermined level causes a first transistor to turn on.

5. The solar powered outdoor flicker light as described in claim 4 wherein said first transistor is connected to a second transistor which illuminates said continuously lit light emitting diode.

6. The solar powered outdoor flicker light as described in claim 5 wherein said second transistor is turned on the illumination state of the flickering light emitting diodes is determined by a third transistor.

7. The solar powered outdoor flicker light as described in claim 6 wherein an astable multi-vibrator circuit is used to cause said flickering light emitting diodes to flicker.

8. The solar powered outdoor flicker light as described in claim 1 wherein said solar panel is a crystalline solar panel.

9. The solar powered outdoor flicker light as described in claim 1 wherein said solar panel is an amorphous solar panel.

10. A circuit for controlling the flickering of light emitting diodes behind the lens of a solar powered outdoor light fixture, said flickering of said light emitting diodes being made to give the appearance of a flickering candle flame, said circuit comprising:
an electrical energy source;
a switch for controlling the flow of electrical energy from said electrical energy source;
a light sensor positioned to provide a signal on the detection of a light level below a predetermined threshold;
a first transistor electrically connected to said light sensor so that said first transistor will be turned on upon receipt of said signal from said light sensor;
a second transistor;
a first light emitting diode;
said second transistor being connected to said first transistor so that said second transistor will provide a continuous flow of electrical energy to said first LED when said first transistor is turned on;
a third transistor
a plurality of second light emitting diodes;
an astable multi-vibrator circuit portion;
said third transistor being connection to said first transistor and said astable multi-vibrator circuit so that said plurality of second light emitting diodes will flicker.

11. The circuit as defined in claim 10 wherein said astable multi-vibrator circuit portion contains an array of resistors and capacitors, said characteristics of said resistors and capacitors being selected to determine the flicker rate of said second light emitting diodes.
